(19) United States
(12) Patent Application Publication
(10) Pub. No.: US 2024/0190074 A1
(43) Pub. Date: Jun. 13, 2024

(54) Plasticizing Device, Three Dimensional Molding Device, And Injection Molding Device

(71) Applicant: SEIKO EPSON CORPORATION, Tokyo (JP)

(72) Inventor: Akira KITAHARA, Shiojiri (JP)

(21) Appl. No.: 18/534,806

(22) Filed: Dec. 11, 2023

(30) Foreign Application Priority Data
Dec. 12, 2022 (JP) 2022-197741

(51) Int. Cl. B29C 64/321; B29C 64/386

(52) U.S. Cl. CPC B29C 64/321; B29C 64/386

(57) ABSTRACT

A plasticizing device including a material storage section configured to store a material and to discharge the material from an input port; a plasticizing section including a screw and a case accommodating the screw and in which a supply port communicating with the input port is formed, and configured to plasticize the material to generate a plasticized material; a connecting member including a transparent member and configured to bring the input port and the supply port into communication with each other; and a material sensor including a light emitting section emitting light toward the supply port via the transparent member and a light receiving section receiving reflected light of the light and configured to detect a remaining amount of the material, wherein the connecting member includes a material collision section against which the material collides and that is provided between the input port and the transparent member.

The present application is based on, and claims priority from JP Application Serial Number 2022-197741, filed Dec. 12, 2022, the disclosure of which is hereby incorporated by reference herein in its entirety.

### BACKGROUND

### 1. Technical Field

The present disclosure relates to a plasticizing device, a three dimensional molding device, and an injection molding device.

### 2. Related Art

A three dimensional molding device that molds a molded object by ejecting a material plasticized by a plasticizing device toward a stage and curing the material has been known.

For example, JP-A-2021-35736 describes that in a three dimensional molding device including a remaining state detection section that detects a remaining state of a material stored in a material storage section, the remaining state detection section is an optical sensor that optically detects the remaining state from outside the material storage section via a transparent portion in the material storage section.

However, in the three dimensional molding device described in JP-A-2021-35736, there is a case where the material becomes deposited on the transparent portion. When the material becomes deposited on the transparent portion, the remaining state of the material cannot be accurately detected.

### SUMMARY

One aspect of a plasticizing device according to the present disclosure includes a material storage section that is configured to store a material and that is configured to discharge the material from an input port; a plasticizing section that includes a screw and a case accommodating the screw and in which is formed a supply port communicating with the input port, and that is configured to plasticize the material to generate a plasticized material; a connecting member that includes a transparent member and that is configured to bring the input port and the supply port into communication with each other; and a material sensor that includes a light emitting section that emits light toward the supply port via the transparent member and a light receiving section that receives reflected light of the light and that is configured to detect a remaining amount of the material, wherein the connecting member includes a material collision section against which the material input from the input port collides and the material collision section is provided between the input port and the transparent member.

One aspect of a three dimensional molding device according to the present disclosure includes the one aspect of the plasticizing device and a nozzle that ejects the plasticized material supplied from the plasticizing device toward a stage.

One aspect of an injection molding device according to the present disclosure includes the one aspect of the plasticizing device and a nozzle that injects the plasticized material supplied from the plasticizing device toward a molding die.

### BRIEF DESCRIPTION OF THE DRAWINGS

FIG. 1 is a cross-sectional view schematically showing a three dimensional molding device according to the present embodiment.

FIG. 2 is a perspective view schematically showing a flat screw of the three dimensional molding device according to the present embodiment.

FIG. 3 is a view schematically showing a barrel of the three dimensional molding device according to the present embodiment.

FIG. 4 is a cross-sectional view schematically showing a material storage section of the three dimensional molding device according to the present embodiment.

FIG. 5 is a perspective view schematically showing a connecting member of the three dimensional molding device according to the present embodiment.

FIG. 6 is a cross-sectional perspective view schematically showing the connecting member of the three dimensional molding device according to the present embodiment.

FIG. 7 is a flowchart for explaining an operation of the three dimensional molding device according to the present embodiment.

FIG. 8 is a cross-sectional view for explaining a molded layer forming process of the three dimensional molding device according to the present embodiment.

FIG. 9 is a perspective view schematically showing a connecting member of a three dimensional molding device according to a first modification of the present embodiment.

FIG. 10 is a cross-sectional view schematically showing the connecting member of the three dimensional molding device according to the first modification of the present embodiment.

FIG. 11 is a cross-sectional view schematically showing a three dimensional molding device according to a second modification of the present embodiment.

FIG. 12 is a cross-sectional view schematically showing an injection molding device of the present embodiment.

### DESCRIPTION OF EMBODIMENTS

Hereinafter, desirable embodiments of the present disclosure will be described in detail with reference to the drawings. The embodiments described below should not unduly limit the contents of the present disclosure described in the claims. In addition, all of the configurations described below are not necessarily essential constituent elements of the present disclosure.

### 1. Three Dimensional Molding Device

1.1. Overall configuration

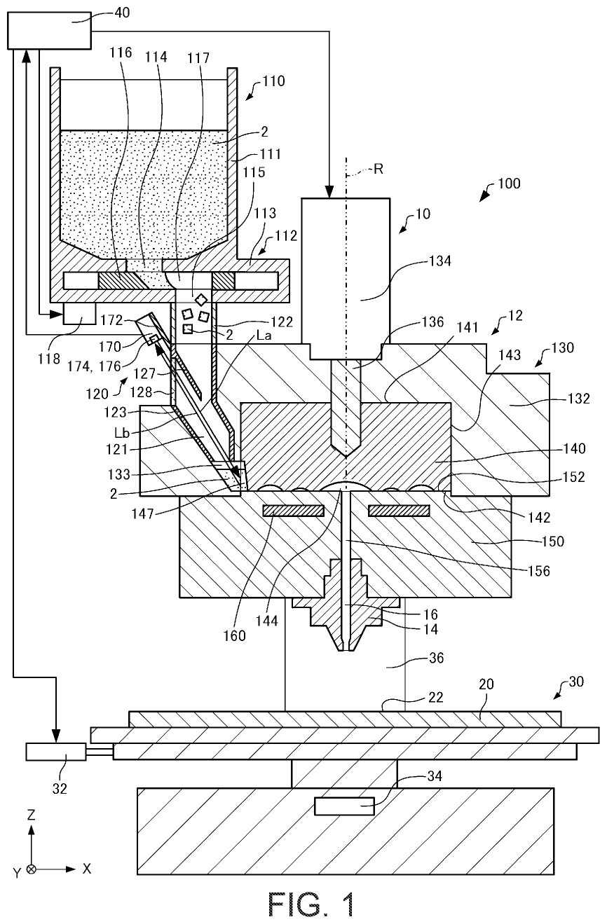

First, a three dimensional molding device according to the present embodiment will be described with reference to the drawings. FIG. 1 is a cross-sectional view schematically showing a three dimensional molding device 100 according to the present embodiment. In FIG. 1, an X-axis, a Y-axis, and a Z-axis are shown as three axes orthogonal to each other. An X-axis direction and a Y-axis direction are, for example, horizontal directions. A Z-axis direction is, for example, a vertical direction.

As shown in FIG. 1, the three dimensional molding device 100 includes, for example, an ejection section 10, a stage 20, a movement section 30, and a control section 40.

The three dimensional molding device 100 changes a relative position between the ejection section 10 and the stage 20 by driving the movement section 30 while ejecting plasticized material from the ejection section 10 toward the stage 20. Thus, the three dimensional molding device 100 molds a three dimensional molded object having a desired shape on the stage 20. The three dimensional molding device 100 is a fused deposition modeling (FDM, registered trademark) type three dimensional molding device.

Although not shown, a plurality of ejection sections 10 may be provided. For example, two ejection sections 10 may be provided. In this case, the two ejection sections 10 may eject plasticized material that will constitute a three dimensional molded object, or one of the ejection sections 10 may eject plasticized material and the other may eject support material for supporting a three dimensional molded object. Two ejection sections 10 may be arranged in the X-axis direction.

The ejection section 10 includes, for example, a plasticizing device 12 and a nozzle 14. The plasticizing device 12 includes, for example, a material storage section 110, a connecting member 120, a plasticizing section 130, and a material sensor 170.

The material storage section 110 stores a material 2 supplied to the plasticizing section 130. The shape of the material 2 is, for example, a pellet shape. The material 2 stored in the material storage section 110 is, for example, acrylonitrile butadiene styrene (ABS) resin. The material 2 stored in the material storage section 110 is supplied to the plasticizing section 130 through the connecting member 120. The material storage section 110 and the connecting member 120 will be described later in detail.

The plasticizing section 130 includes, for example, a screw case 132, a drive motor 134, a flat screw 140, a barrel 150, and a heater 160. The plasticizing section 130 plasticizes the material 2, which is supplied from the material storage section 110 in a solid state, generates a pasty plasticized material having fluidity, and supplies the plasticized material to the nozzle 14.

Plasticization is a concept including melting, and means changing from a solid state to a state having fluidity. Specifically, in a case of a material in which glass transition occurs, plasticization is to raise temperature of the material to the glass transition point or higher. In a case of a material that does not undergo glass transition, plasticization is raising of temperature of the material above its melting point.

The screw case 132 is a housing that accommodates the flat screw 140. The barrel 150 is provided on a lower surface of the screw case 132. The flat screw 140 is accommodated in a space surrounded by the screw case 132 and the barrel 150.

The drive motor 134 is provided on an upper surface of the screw case 132. The drive motor 134 is, for example, a servo motor. A shaft 136 of the drive motor 134 is connected to an upper surface 141 of the flat screw 140. The drive motor 134 is controlled by the control section 40. Although not shown, the shaft 136 and the upper surface 141 of the drive motor 134 may be connected via a decelerator.

The flat screw 140 has a substantially cylindrical shape in which the size in a direction of a rotation axis R is smaller than the size in a direction orthogonal to the direction of the rotation axis R. In the shown example, the rotation axis R is parallel to the Z-axis. The flat screw 140 rotates about the rotation axis R by torque generated by the drive motor 134.

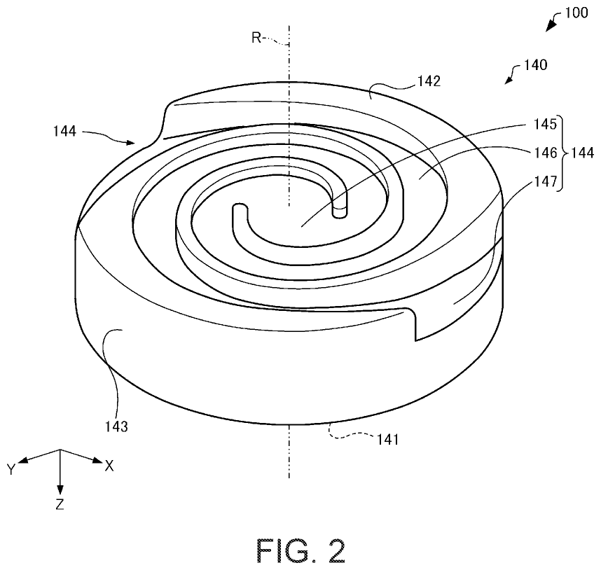

The flat screw 140 includes the upper surface 141, a groove forming surface 142 on an opposite side from the upper surface 141, and a side surface 143 connecting the upper surface 141 and the groove forming surface 142. First grooves 144 are formed in the groove forming surface 142. The side surface 143 is, for example, perpendicular to the groove forming surface 142. FIG. 2 is a perspective view schematically showing the flat screw 140. For convenience, FIG. 2 shows a state in which the vertical positional relationship is reversed from the state shown in FIG. 1.

As shown in FIG. 2, first grooves 144 are formed in the groove forming surface 142 of the flat screw 140. The first grooves 144 include, for example, a central section 145, a connection section 146, and a material inlet section 147. The central section 145 faces a communication hole 156 formed in the barrel 150. The central section 145 communicates with the communication hole 156. The connection section 146 connects the central section 145 and the material inlet section 147. In the shown example, the connection section 146 is provided in a spiral shape from the central section 145 toward the outer circumference of the groove forming surface 142. The material inlet section 147 is provided on the outer circumference of the groove forming surface 142. That is, the material inlet section 147 is provided on the side surface 143 of the flat screw 140. A material supplied from the material storage section 110 is introduced from the material inlet section 147 into the first grooves 144, passes through the connection section 146 and the central section 145, and is transported to the communication hole 156 formed in the barrel 150. For example, two first grooves 144 are provided.

The number of first grooves 144 is not particularly limited. Although not shown, three or more first grooves 144 may be provided, or only one first groove may be provided.

Although not shown, instead of the flat screw 140, the plasticizing section 130 may have an elongate in-line screw including a helical groove on a side surface. The plasticizing section 130 may plasticize the material 2 by rotation of the in-line screw.

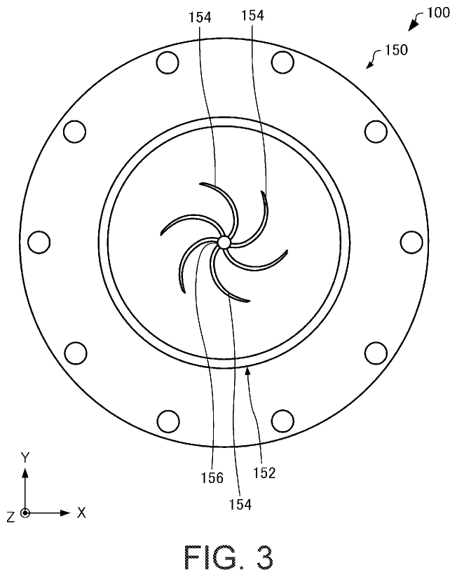

As shown in FIG. 1, the barrel 150 is provided below the flat screw 140. The barrel 150 includes a facing surface 152 that faces the groove forming surface 142 of the flat screw 140. The communication hole 156 communicating with the first groove 144 is formed at a center of the facing surface 152. FIG. 3 is a plan view schematically showing the barrel 150.

As shown in FIG. 3, second grooves 154 and the communication hole 156 are formed in the facing surface 152 of the barrel 150. A plurality of second grooves 154 is formed. In the shown example, six second grooves 154 are formed, but the number of second grooves 154 is not particularly limited. The plurality of second grooves 154 is formed around the communication hole 156, when viewed from the Z-axis direction. The second grooves 154 have one end connected to the communication hole 156 and extend in a spiral shape from the communication hole 156 toward the outer circumference of the barrel 150. The second grooves 154 have a function of guiding the plasticized material to the communication hole 156.

The shape of the second grooves 154 is not particularly limited, and may be, for example, linear. The one end of the second grooves 154 may not be connected to the communication hole 156. Further, the second grooves 154 may not be formed on the facing surface 152. However, in consideration of efficiently guiding the plasticized material to the communication hole 156, the second grooves 154 are desirably formed on the facing surface 152.

As shown in FIG. 1, the heater 160 is provided in the barrel 150. The heater 160 heats the material 2 supplied between the flat screw 140 and the barrel 150. Output of the heater 160 is controlled by the control section 40. By using the flat screw 140, the barrel 150, and the heater 160, the plasticizing section 130 generates plasticized material by heating the material 2 while transporting the material 2 toward the communication hole 156. Then, the plasticizing section 130 causes the generated plasticized material to flow out from the communication hole 156.

The heater 160 may have a ring shape as viewed in the Z-axis direction. The heater 160 may be provided, for example, below the barrel 150 instead of in the barrel 150.

The nozzle 14 is provided below the barrel 150. A nozzle flow path 16 is formed in the nozzle 14. The nozzle flow path 16 communicates with the communication hole 156. The plasticized material is supplied to the nozzle flow path 16 from the communication hole 156. The nozzle 14 ejects the plasticized material supplied from the plasticizing device 12 toward the stage 20.

The stage 20 is provided below the nozzle 14. In the shown example, the shape of the stage 20 is a rectangular parallelepiped. The stage 20 includes a deposition surface 22 on which the plasticized material is deposited. The deposition surface 22 is a region of an upper surface of the stage 20.

The material of the stage 20 is, for example, a metal such as aluminum. The stage 20 may be constituted by a metal plate and an adhesive sheet provided on the metal plate. In this case, the deposition surface 22 is constituted by the adhesive sheet. The adhesive sheet can improve adhesion between the stage 20 and the plasticized material ejected from the ejection section 10. Although not shown, the stage 20 may be constituted by a metal plate in which grooves are formed and an underlying layer provided so as to fill the grooves. In this case, the deposition surface 22 is constituted by the underlying layer. The material of the underlying layer is, for example, the same as the plasticized material. The underlying layer can improve adhesion between the stage 20 and the plasticized material discharged from the ejection section 10.

The movement section 30 supports the stage 20. The movement section 30 changes a relative position between the ejection section 10 and the stage 20. In the shown example, the movement section 30 changes the relative position between the nozzle 14 and the stage 20 in the X-axis direction and the Y-axis direction by moving the stage 20 in the X-axis direction and the Y-axis direction. Further, the movement section 30 changes the relative position of the nozzle 14 and the stage 20 in the Z-axis direction by moving the ejection section 10 in the Z-axis direction.

The movement section 30 includes, for example, a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejection section 10 in the Z-axis direction.

The configuration of the movement section 30 is not particularly limited as long as the relative position between the ejection section 10 and the stage 20 can be changed. For example, the movement section 30 may be configured to move the stage 20 in the Z-axis direction and move the ejection section 10 in the X-axis direction and the Y-axis direction. Alternatively, the movement section 30 may be configured to move the stage 20 or the ejection section 10 in the X-axis direction, the Y-axis direction, and the Z-axis direction.

The control section 40 is configured by, for example, a computer including a processor, a main storage device, and an input/output interface that performs input and output of signals with the outside. The control section 40 exhibits various functions by, for example, causing the processor to execute programs read into the main storage device. Specifically, the control section 40 controls the ejection section 10 and the movement section 30. The control section 40 may be configured by a combination of a plurality of circuits instead of the computer.

### 1. 2. Material Storage Section

The material storage section 110 is supported, for example, by a support member (not shown). The material storage section 110 includes, for example, a hopper 111 and a material supply mechanism 112. The hopper 111 stores the material 2.

The material supply mechanism 112 is connected to the hopper 111. The material supply mechanism 112 is provided below the hopper 111. The material supply mechanism 112 supplies the material 2 to a connecting path 121 of the connecting member 120. The material supply mechanism 112 includes, for example, a guide case 113, a material intermittent-supply plate 116, and an intermittent-supply plate drive section 118.

The inside of the guide case 113 is hollow. The guide case 113 is formed with a material inlet 114 provided on a hopper 111 side and an input port 115 provided on a connecting member 120 side. The material inlet 114 allows communication between the inside of the guide case 113 and the inside of the hopper 111. The input port 115 allows communication between the inside of the guide case 113 and the connecting path 121.

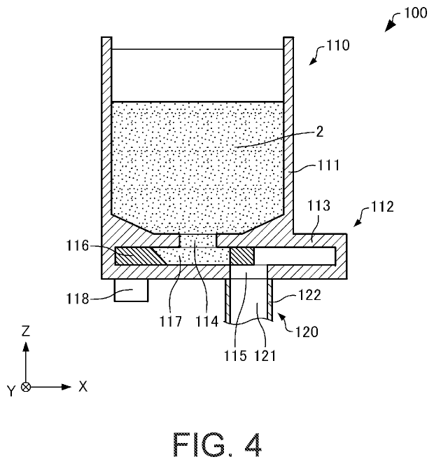

The material intermittent-supply plate 116 is provided inside the guide case 113. A through hole 117 is formed in the material intermittent-supply plate 116. The through hole 117 penetrates the material intermittent-supply plate 116. In the example shown in FIG. 4, the through hole 117 is in communication with the material inlet 114. Therefore, the material 2 inside the hopper 111 is supplied to the through hole 117 through the material inlet 114.

The material intermittent-supply plate 116 slides in the X-axis direction in the guide case 113 and reciprocates by the intermittent-supply plate drive section 118. In the example shown in FIG. 1, the through hole 117 communicates with the input port 115. Therefore, the material 2 in the through hole 117 is supplied to the connecting path 121 through the input port 115.

Here, FIG. 4 is a cross-sectional view schematically showing the material storage section 110. In the example shown in FIG. 4, the material intermittent-supply plate 116 is moved in a −X-axis direction more than in the example shown in FIG. 1. In the example shown in FIG. 4, the input port 115 does not overlap the through hole 117 as viewed in the Z-axis direction. Therefore, the material 2 in the through hole 117 is not supplied to the connecting path 121.

The intermittent-supply plate drive section 118 slides the material intermittent-supply plate 116 in the X-axis direction. The intermittent-supply plate drive section 118 is not particularly long as it can slide the material intermittent-supply plate 116 in the X-axis direction, but is configured to include, for example, an air cylinder. The intermittent-supply plate drive section 118 is controlled by the control section 40.

The intermittent-supply plate drive section 118 switches the material storage section 110 between a first state and a second state by sliding the material intermittent-supply plate 116 in the X-axis direction. In the first state, as shown in FIG. 1, the through hole 117 communicates with the input port 115, and the material 2 is input from the input port 115 to the connecting member 120. In the second state, as shown in FIG. 4, the through hole 117 and the input port 115 do not communicate with each other, and the material 2 is not input from the input port 115 to the connecting member 120. Thus, the material storage section 110 can discharge a predetermined amount of the material 2 from the input port 115 to the connecting member 120, or stop supply of the material 2 to the connecting member 120.

### 1. 3. Connecting Member

As shown in FIG. 1, the connecting member 120 is provided at a side of the flat screw 140. The connecting member 120 is provided in a direction orthogonal to the rotation axis R of the flat screw 140. In the shown example, the connecting member 120 is provided in the −X-axis direction of the flat screw 140.

The connecting member 120 connects the input port 115 formed in the material storage section 110 and a supply port 133 formed in the screw case 132. The connecting member 120 is a tubular member in which the connecting path 121 is formed. The connecting path 121 connects the input port 115 and the supply port 133.

The connecting member 120 includes, for example, a pipe section 122, a main body section 123, and a transparent member 128. The pipe section 122 connects the material storage section 110 and the main body section 123. In the shown example, the pipe section 122 is spaced apart from the screw case 132. The main body section 123 is provided in the screw case 132. The material of the pipe section 122 and the main body section 123 is, for example, metal or resin.

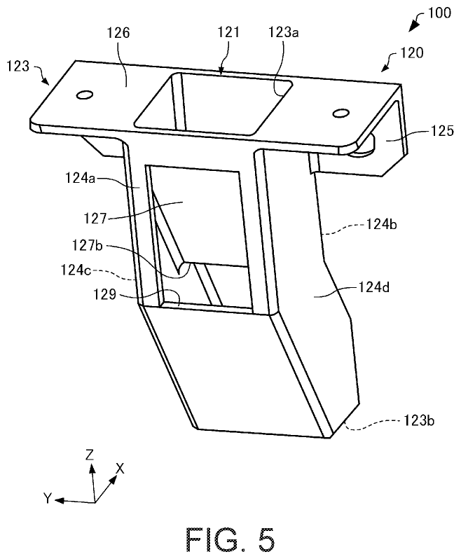

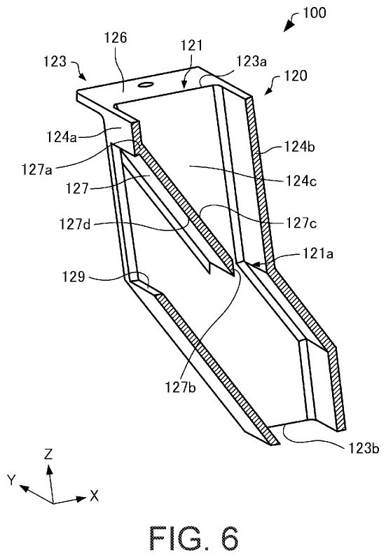

FIG. 5 is a perspective view schematically showing the main body section 123 of the connecting member 120. FIG. 6 is a cross-sectional perspective view schematically showing the main body section 123 of the connecting member 120.

As shown in FIGS. 5 and 6, an inlet 123a and an outlet 123b are formed in the main body section 123. The connecting path 121 includes the inlet 123a and the outlet 123b. The material 2 input from the input port 115 passes through the pipe section 122, reaches the inlet 123a, is discharged from the outlet 123b to the supply port 133, and reaches the material inlet section 147. As viewed in the Z-axis direction, the center of the outlet 123b is positioned closer to the flat screw 140 than the center of the inlet 123a, for example.

The main body section 123 includes, for example, a first side wall section 124a, a second side wall section 124b, a third side wall section 124c, a fourth side wall section 124d, a first fixing section 125, a second fixing section 126, and a material collision section 127.

The first side wall section 124a and the second side wall section 124b face each other. The third side wall section 124c and the fourth side wall section 124d face each other. The third side wall section 124c connects the first side wall section 124a and the second side wall section 124b. The fourth side wall section 124d connects the first side wall section 124a and the second side wall section 124b. The second side wall section 124b is provided on the flat screw 140 side. The first side wall section 124a is provided on the opposite side of the flat screw 140. Side wall sections 124a, 124b, 124c, and 124d constitute the inlet 123a and the outlet 123b. In the example shown in FIG. 6, the inlet 123a and the outlet 123b are substantially rectangular in shape. The shapes of the inlet 123a and the outlet 123b are not particularly limited, and may be circular or elliptical.

As shown in FIG. 5, the first fixing section 125 is connected to the third side wall section 124c and the fourth side wall section 124d. The main body section 123 is fixed to the screw case 132 by the first fixing section 125. The main body section 123 is screwed to the screw case 132 by, for example, a first fixing section 125.

The second fixing section 126 is connected to the third side wall section 124c and the fourth side wall section 124d. The second fixing section 126 is provided in the vicinity of the inlet 123a. The main body section 123 is fixed to the pipe section 122 by the second fixing section 126. The main body section 123 is screwed to the pipe section 122 by, for example, the second fixing section 126. The connecting member 120 may not include the pipe section 122. In this case, the main body section 123 is fixed to the material storage section 110 by the second fixing section 126.

The material collision section 127 is connected to the first side wall section 124a. The material collision section 127 is separated from the second side wall section 124b. The material collision section 127 extends from the first side wall section 124a toward the second side wall section 124b while being inclined in the Z-axis direction. The material collision section 127 extends in a direction intersecting the Z-axis and approaching the supply port 133. The material collision section 127 defines a narrowed section 121a in the connecting path 121. In the shown example, a first end section 127a of the material collision section 127 is connected to the first side wall section 124a. A second end section 127b of the material collision section 127 defines a narrowed section 121a. In the shown example, the narrowed section 121a is defined by the second end section 127b and the second side wall section 124b. The second end section 127b is an end section opposite to the first end section 127a.

The material collision section 127 is provided between the input port 115 and the transparent member 128 in the connecting path 121. The material collision section 127 is provided between the inlet 123a and the transparent member 128. The material collision section 127 has a plate-like shape, for example. The material 2 input from the inlet 123a collides the material collision section 127. In other words, the material collision section 127 receives the material 2 input from the inlet 123a. An input direction of the material 2 is a direction from the center of the input port 115 toward the center of the inlet 123a. In the shown example, the input direction of the material 2 is a −Z-axis direction.

The material collision section 127 includes a first surface 127c and a second surface 127d. The material 2 input from the input port 115 collides with the first surface 127c. The second surface 127d is a surface opposite to the first surface 127c. In the shown example, the first surface 127c and the second surface 127d are parallel to each other. The first surface 127c and the second surface 127d are provided along a direction inclined in the Z-axis direction. The material 2 input from the input port 115 passes through the inlet 123a, collides the first surface 127c, slides down the first surface 127c, passes through the narrowed section 121a, and is discharged from the outlet 123b to the supply port 133.

As shown in FIG. 5, the transparent member 128 is provided in an opening section 129 formed in the first side wall section 124a. The transparent member 128 is fitted in the opening section 129, for example. The opening section 129 penetrates through the first side wall section 124a. The transparent member 128 is configured to be attachable to and detachable from the opening section 129. For example, the transparent member 128 is configured to be attachable to and detachable from the opening section 129 by being screwed to the opening section 129.

The transparent member 128 is provided to the second surface 127d side of the material collision section 127. The material collision section 127 is a canopy that suppresses contact of the material 2 with the transparent member 128. The transparent member 128 overlaps the material collision section 127 when viewed in the X-axis direction. In the shown example, the transparent member 128 extends in the Z-axis direction. The transparent member 128 has a plate-like shape, for example.

The transparent member 128 is a member having transparency capable of transmitting light La from the material sensor 170 and reflected light Lb of the light La. The transparent member 128 desirably has a transmittance of 30% or more and 100% or less for visible light, infrared light and the like, and more desirably has a transmittance of 50% or more and 100% or less. The material of the transparent member 128 is, for example, acrylic resin, polycarbonate, or glass.

### 1. 4. Material Sensor

As shown in FIG. 1, the material sensor 170 is provided to the outside of the connecting member 120. The material sensor 170 is provided obliquely above the transparent member 128. The material sensor 170 is supported, for example, by a support section 172. The support section 172 extends obliquely upward from the first side wall section 124a of the connecting member 120.

The material sensor 170 includes a light emitting section 174 and a light receiving section 176. The light emitting section 174 emits light La toward the supply port 133 via the transparent member 128. The light emitting section 174 is, for example, a laser or a light emitting diode (LED). The light receiving section 176 receives reflected light Lb of the light La. Specifically, the light receiving section 176 receives the reflected light Lb of the light La reflected by the material 2 via the transparent member 128. The light receiving section 176 is a Photodiode (PD). The material collision section 127 is provided between an optical path of the light La and the input port 115.

The material sensor 170 detects the material 2 of the material inlet section 147 of the first groove 144 formed in the flat screw 140. The material sensor 170 detects the remaining amount of the material 2 in the material inlet section 147. The material sensor 170 has a predetermined measurement range. The measurement range of the material sensor 170 is defined so as to exclude a position of the transparent member 128. The measurement range of the material sensor 170 is set so as to include a position of the material inlet section 147. The material sensor 170 is configured to detect the material 2 in a predetermined range.

### 1.5. Operation

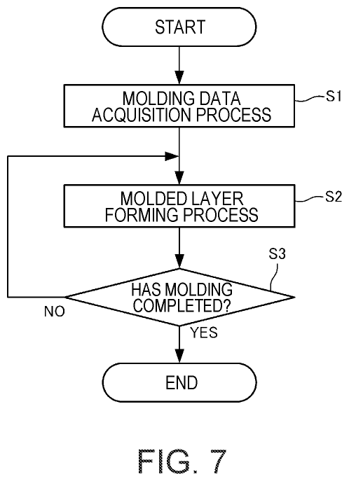

FIG. 7 is a flowchart for explaining an operation of the three dimensional molding device 100. Specifically, FIG. 7 is a flowchart for explaining a process of the control section 40.

### 1.5.1. Molding Data Acquisition Process

For example, a user operates an operation section (not shown) to output a process start signal for starting a process to the control section 40. The operation section is configured by, for example, a mouse, a keyboard, a touch panel, or the like. The control section 40 starts a process when receiving the process start signal.

First, as shown in FIG. 7, in step S1, the control section 40 performs a molding data acquisition process for acquiring molding data for molding a three dimensional molded object.

The molding data includes, for example, information regarding a type of the material 2 stored in the material storage section 110, a movement path of the ejection section 10 with respect to the stage 20, the amount of the plasticized material ejected from the ejection section 10, and the like.

The molding data is created, for example, by reading shape data into slicer software installed in a computer connected to the three dimensional molding device 100. The shape data is data representing a target shape of a three dimensional molded object created using three dimensional computer aided design (CAD) software, three dimensional computer graphics (CG) software, or the like. As the shape data, for example, data in a standard triangulated language (STL) format or an additive manufacturing file format (AMF), or the like is used. The slicer software divides the target shape of the three dimensional molded object into layers each having a predetermined thickness, and creates molding data for each layer. The molding data is represented by a G-code, an M-code, or the like. The control section 40 acquires molding data from a computer connected to the three dimensional molding device 100 or a recording medium such as a universal serial bus (USB) memory.

### 1.5.2. Molded Layer Forming Process

Next, in step S2, the control section 40 performs a molded layer forming process for forming a molded layer by ejecting the plasticized material onto the deposition surface 22 of the stage 20.

Specifically, the control section 40 plasticizes the material 2 supplied between the flat screw 140 and the barrel 150 to generate the plasticized material, and ejects the plasticized material from the nozzle 14 of the ejection section 10. The control section 40 continues to generate the plasticized material, for example, until the molded layer forming process is completed. The control section 40 controls the intermittent-supply plate drive section 118 of the material storage section 110 on the basis of a detection signal from the material sensor 170 so that the plasticized material in the material inlet section 147 of the first groove 144 formed in the flat screw 140 is not exhausted until the molded layer forming process is completed.

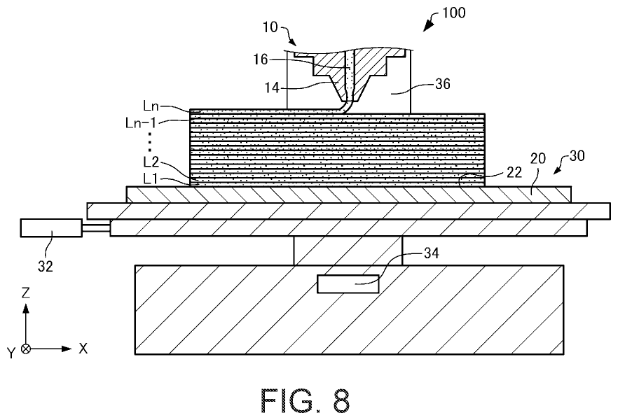

Here, FIG. 8 is a cross-sectional view for explaining the molded layer forming process of the three dimensional molding device 100.

As shown in FIG. 8, the control section 40 controls the ejection section 10 to eject the plasticized material from the nozzle 14 toward the stage 20 while changing a relative position between the ejection section 10 and the stage 20 by controlling the movement section 30 based on the acquired molding data.

Specifically, before the molded layer forming process is started, that is, before a formation of a molded layer L1, which is a first molded layer, is started, the nozzle 14 is arranged at an initial position in the −X-axis direction with respect to the end section of the stage 20 in the −X-axis direction. When the molded layer forming process is started, as shown in FIG. 8, the control section 40 relatively moves the nozzle 14 in a +X-axis direction with respect to the stage 20 by controlling the movement section 30. When the nozzle 14 passes over the stage 20, the plasticized material is ejected from the nozzle 14. Accordingly, the molded layer L1 is formed. In FIG. 8, “n” is an arbitrary natural number, and layers up to the “n”-th molded layer Ln are shown.

### 1.5.3. Determination Process

Next, as shown in FIG. 7, in step S3, the control section 40 performs a determination process of determining whether or not a formation of all the molded layers is completed based on the molding data.

In a case where it is determined that the formation of all the molded layers is not completed (“NO” in step S3), the control section 40 returns the process to step S2. In step S3, the control section 40 repeats step S2 and step S3 until it is s is determined that the formation of all the molded layers completed.

On the other hand, when it is determined that the formation of all the molded layers is completed (“YES” in step S3), the control section 40 ends the process.

### 1.6. Operations and Effects

The plasticizing device 12 includes the connecting member 120 including the transparent member 128 and that communicates the input port 115 with the supply port 133, and the material sensor 170 including the light emitting section 174 that emits light La toward the supply port 133 via the transparent member 128 and the light receiving section 176 that receives reflected light Lb of the light La and that detects the remaining amount of the material 2 The connecting member 120 includes the material collision section 127 with which the material 2 input from the input port 115 collides, and the material collision section 127 is provided between the input port 115 and the transparent member 128.

Therefore, in the plasticizing device 12, the material collision section 127 can reduce the possibility that the material 2 input from the input port 115 becomes deposited on the transparent member 128. Thus, in the plasticizing device 12, the remaining amount of the material 2 can be accurately detected by the material sensor 170.

In the plasticizing device 12, the connecting member 120 includes the first side wall section 124a, the material collision section 127 extends from the first side wall section 124a in a direction intersecting the input direction of the material 2 and in a direction approaching the supply port 133, the opening section 129 is formed in the first side wall section 124a, and the transparent member 128 is provided in the opening section 129. Therefore, in the plasticizing device 12, the material 2 input from the input port 115 can slide down the material collision section 127 and be discharged to the supply port 133.

In the plasticizing device 12, the transparent member 128 is configured to be attachable and detachable. Therefore, even when the material 2 becomes deposited on the transparent member 128 in the plasticizing device 12, the transparent member 128 can be replaced.

In the plasticizing device 12, the material sensor 170 has a predetermined measurement range. Therefore, by defining a measurement range of the material sensor 170 so that a position of the transparent member 128 is excluded from the measurement range of the material sensor 170 in the plasticizing device 12, even when the material 2 becomes deposited on the transparent member 128, it is possible to make it so that the material 2 deposited on the transparent member 128 is not detected.

In the plasticizing device 12, the first groove 144 is formed in the flat screw 140, and the material sensor 170 detects the material 2 in the first groove 144. Therefore, it is possible to suppress running out of the material 2 in the first groove 144 during the molded layer forming process in the plasticizing device 12.

In the plasticizing device 12, the material storage section 110 includes the material intermittent-supply plate 116 as a slide member in which a through hole 117 is formed, and the intermittent-supply plate drive section 118 as a slide drive section for sliding the material intermittent-supply plate 116. By sliding the material intermittent-supply plate 116, the intermittent-supply plate drive section 118 switches between a first state in which the through hole 117 and the input port 115 communicate with each other and the material 2 is input from the input port 115 to the connecting member 120 and a second state in which the through hole 117 and the input port 115 do not communicate with each other and the material 2 is not input from the input port 115 to the connecting path 121. Therefore, the plasticizing device 12 can adjust the supply amount of the material 2 to the plasticizing section 130.

### 2. Modifications of Three Dimensional Molding Device

### 2.1. First Modification

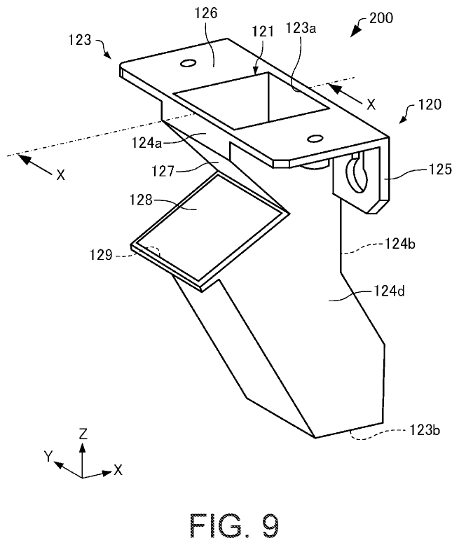

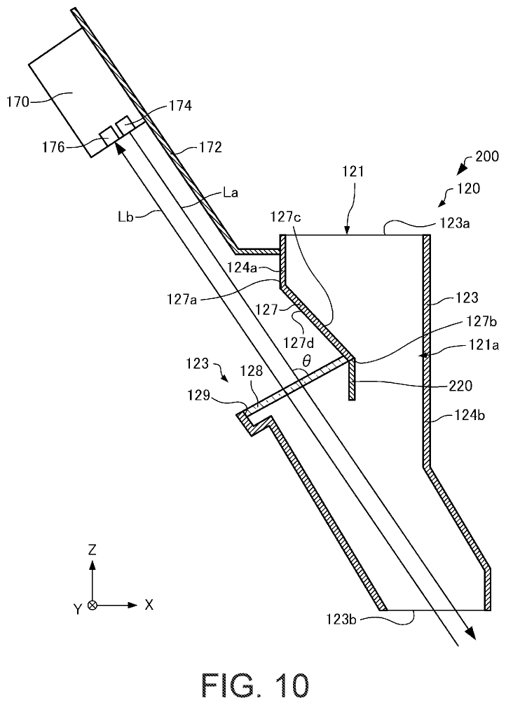

Next, a three dimensional molding device according to a first modification of the present embodiment will be described with reference to the drawings. FIG. 9 is a perspective view schematically showing the connecting member 120 of a three dimensional molding device 200 according to the first modification of the present embodiment. FIG. 10 is a cross-sectional view of the connecting member 120 of the three dimensional molding device 200 according to the first modification of the present embodiment taken along the line X-X of FIG. 9. For convenience, the pipe section 122 of the connecting member 120 is not shown in FIGS. 9 and 10.

Hereinafter, in the three dimensional molding device 200 according to the first modification of the present embodiment, members having the same functions as the constituent members of the three dimensional molding device 100 according to the present embodiment described above are denoted by the same reference numerals, and detailed description thereof will be omitted. This is the same in a three dimensional molding device according to a second modification (to be described later).

In the three dimensional molding device 200, as shown in FIGS. 9 and 10, the shape of the main body section 123 of the connecting member 120 is different from that of the three dimensional molding device 100 described above.

The material collision section 127 constitutes a side wall of the connecting member 120. The transparent member 128 extends in a direction different from an extending direction of the material collision section 127 and intersecting the Z-axis direction. In the shown example, the transparent member 128 is connected to the second end section 127b of the material collision section 127. As viewed in the Z-axis direction, at least a part of the transparent member 128 overlaps the material collision section 127. The material collision section 127 and the transparent member 128 form a bent shape.

As shown in FIG. 10, the connecting member 120 includes a wall section 220. The shape of the wall section 220 has a plate-like shape, for example. For example, the wall section 220 is connected to the second end section 127b of the material collision section 127. In the shown example, the wall section 220 extends in the −Z-axis direction from the second end section 127b. The wall section 220 can reduce possibility that the material 2 becomes deposited on the transparent member 128.

In the three dimensional molding device 200, the material collision section 127 extends in a direction intersecting the input direction of the material 2, the transparent member 128 extends in a direction different from the extending direction of the material collision section 127 and intersecting the input direction, and at least a part of the transparent member 128 overlaps the material collision section 127 when viewed from the input direction. Therefore, it is easy to make the incident angle θ of the light La from the light emitting section 174 to the transparent member 128 close to vertical. Thus, the loss of the light La in the transparent member 128 can be reduced. The incident angle θ is, for example, 80° or more and 100° or less, and desirably 85° or more and 95° or less.

### 2.2. Second Modification

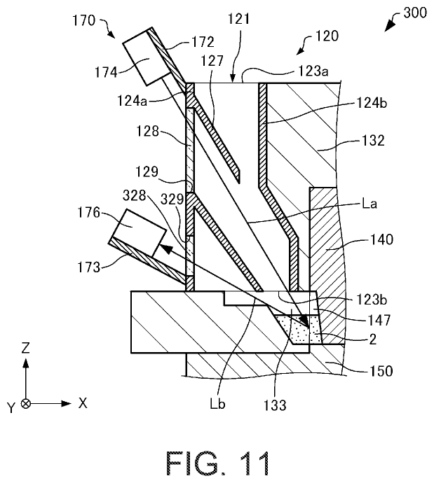

Next, a three dimensional molding device according to a second modification of the present embodiment will be described with reference to the drawings. FIG. 11 is a cross-sectional view schematically showing a three dimensional molding device 300 according to the second modification of the present embodiment.

As shown in FIG. 11, the three dimensional molding device 300 is different from the three dimensional molding device 100 described above in that it includes a transparent member 328 through which the reflected light Lb passes.

The transparent member 328 is provided in an opening section 329 formed in the first side wall section 124a. The transparent member 128 is fitted in the opening section 329, for example. The opening section 329 penetrates through the first side wall section 124a. In the shown example, the transparent member 328 is provided below the transparent member 128. The transparent member 328 is configured to be attachable and detachable, for example.

The light emitting section 174 and the light receiving section 176 of the material sensor 170 are separated from each other. The light emitting section 174 is supported by the support section 172. The light receiving section 176 is supported by the support section 173. The support section 173 extends obliquely upward from the first side wall section 124a. In the shown example, the light receiving section 176 is provided below the light emitting section 174.

The light La emitted from the light emitting section 174 reaches the material 2 in the material inlet section 147 through the transparent member 128. The reflected light Lb of the light La reflected by the material 2 passes through the transparent member 328 and is received by the light receiving section 176.

In the three dimensional molding device 300, the connecting member 120 includes another transparent member 328 through which the reflected light Lb passes. Therefore, in the three dimensional molding device 300, when the light La is emitted from the light emitting section 174 but is not received by the light receiving section 176, it can be detected that the material 2 is deposited to at least one of the transparent member 128 and the transparent member 328. Therefore, it is possible to detect the timing of replacement of the transparent members 128, 328.

### 2.3. Third Modification

Next, a three dimensional molding device according to a third modification of the present embodiment will be described. In the three dimensional molding device according to the third modification of the present embodiment, points different from those of the three dimensional molding device 100 according to the present embodiment described above will be described below, and a description of the same points will be omitted.

In the three dimensional molding device 100 described above, the material 2 stored in the material storage section 110 is ABS resin.

On the other hand, in the three dimensional molding device according to the third modification of the present embodiment, the material stored in the material storage section 110 is a material other than ABS resin or a material obtained by adding other components to ABS resin.

Examples of the material stored in the material storage section 110 include various materials such as a material having thermoplasticity, a metal material, and a ceramic material as a main material. Here, the “main material” means a material which is a center forming the shape of the molded object molded by the three dimensional molding device, and means a material which occupies a content rate of 50% by mass or more in the molded object. The above-described materials include a material obtained by melting these main materials as a single substance and a material obtained by melting a part of components contained together with the main materials to form a paste.

As the material having thermoplasticity, for example, a thermoplastic resin can be used. Examples of the thermoplastic resin include general-purpose engineering plastic and super engineering plastic.

Examples of the general-purpose engineering plastic include PolyPropylene (PP); PolyEthylene (PE); PolyOxyMethylene (POM); PolyVinylChloride (PVC); PolyAmide (PA); PolyLacticAcid (PLA); PolyPhenyleneSulfide (PPS); PolyCarbonate (PC); modified polyphenylene ether; polybutylene terephthalate and polyethylene terephthalate.

Examples of the super engineering plastic include PolySUlfone (PSU); PolyEtherSulfone (PES); PolyPhenylene Sulfide (PPS); PolyARylate (PAR); PolyImide (PI); PolyAmideImide (PAI); PolyEtherImide (PEI) and PolyEtherEtherKetone (PEEK).

The material having thermoplasticity may contain a pigment, metal, ceramic, or other additive such as wax, a flame retardant, an antioxidant, or a heat stabilizer. The material having thermoplasticity is plasticized and converted into a melted state by the rotation of the flat screw 140 and the heating of the heater 160 in the plasticizing device 12. The plasticized material so generated is also cured by a decrease in temperature after it is deposited from the nozzle 14. The material having thermoplasticity is desirably heated to a temperature equal to or higher than the glass transition point and ejected from the nozzle 14 in a completely melted state.

In the plasticizing device 12, for example, a metal material may be used as the main material instead of the above-described material having thermoplasticity. In this case, it is desirable that the powder material obtained by pulverizing the metal material is mixed with a component that melts when the plasticized material is generated, and the mixture is input into the plasticizing device 12.

Examples of the metal material include single metals as Magnesium (Mg), Iron (Fe), Cobalt (Co), Chromium (Cr), Aluminum (Al), Titanium (Ti), Copper (Cu), Nickel (Ni), or alloys containing one or more of these metals, and maraging steel, stainless steel, cobalt chromium molybdenum, titanium alloy, nickel alloy, aluminum alloy, cobalt alloy, cobalt-chromium alloy.

In the plasticizing device 12, a ceramic material can be used as a main material instead of the above-described metal material. Examples of the ceramic material include oxide ceramics such as silicon dioxide, titanium dioxide, aluminum oxide, and zirconium oxide, and non-oxide ceramics such as aluminum nitride.

The powder material of the metal material or the ceramic material stored in the material storage section 110 may be a powder of a single metal, a powder of an alloy, or a mixed material obtained by mixing a plurality of types of powders of ceramic materials. The powder material of the metal material or the ceramic material may be coated with, for example, the above-described thermoplastic resin or another thermoplastic resin. In this case, the thermoplastic resin may be melted in the plasticizing device 12 to exhibit fluidity.

For example, a solvent may be added to the powder material of the metal material or the ceramic material stored in the material storage section 110. Solvents include, for example, water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetylacetone; alcohols such as ethanol, propanol and butanol; tetraalkylammonium acetates; sulfoxide solvent such as dimethyl sulfoxide and diethyl sulfoxide; a pyridine solvent such as pyridine, γ-picoline and 2, 6-lutidine; tetraalkylammonium acetate (for example, tetrabutylammonium acetate); ionic liquid such as butylcarbitol acetate; and the like.

In addition, for example, a binder may be added to the powder material of the metal material or the ceramic material stored in the material storage section 110. Examples of the binder include acrylic resin; epoxy resin; silicone resin; cellulosic resin or other synthetic resin, or PLA, PA, PPS, PEEK or other thermoplastic resin.

### 3. Injection Molding Device

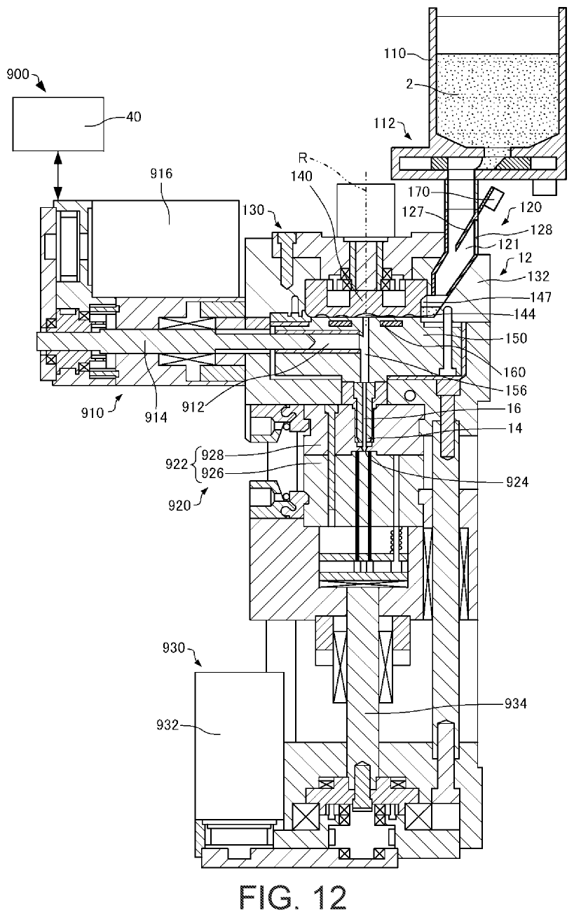

Next, an injection molding device according to the present embodiment will be described with reference to the drawings. FIG. 12 is a cross-sectional view schematically showing an injection molding device 900 according to the present embodiment.

The injection molding device 900, as shown in FIG. 12, includes, for example, the plasticizing device 12 described above. The injection molding device 900 further includes, for example, a nozzle 14, an injection mechanism 910, a mold section 920, and a molding die clamping section 930.

The plasticizing device 12 plasticizes the material 2 supplied to the first groove 144 of the flat screw 140, generates a pasty plasticized material having fluidity, and guides the plasticized material from the communication hole 156 to the injection mechanism 910.

The injection mechanism 910 includes, for example, a cylinder 912, a plunger 914, and a plunger drive section 916. The cylinder 912 is a substantially cylindrical member connected to the communication hole 156. The plunger 914 moves inside the cylinder 912. The plunger 914 is driven by a plunger drive section 916 configured by a motor, a gear, and the like. The plunger drive section 916 is controlled by the control section 40.

The injection mechanism 910 performs a measurement operation and an injection operation by sliding the plunger 914 in the cylinder 912. The measurement operation refers to an operation in which the plunger 914 is moved in a direction away from the communication hole 156 to guide the plasticized material located in the communication hole 156 into the cylinder 912 and to measure the plasticized material in the cylinder 912. The injection operation refers to an operation of injecting the plasticized material in the cylinder 912 into the mold section 920 via the nozzle 14 by moving the plunger 914 in a direction approaching the communication hole 156.

The nozzle 14 injects the plasticized material supplied from the plasticizing device 12 toward a molding die 922 of the mold section 920. Specifically, by performing the above-described measurement operation and injection operation, the plasticized material measured in the cylinder 912 is sent from the injection mechanism 910 to the nozzle 14 via the communication hole 156. Then, the plasticized material is injected from the nozzle 14 into the mold section 920.

The mold section 920 includes the molding die 922. The molding die 922 is a metal mold. The molding die 922 includes a movable molding die 926 and a fixed molding die 928 which face each other, and includes a cavity 924 between the movable molding die 926 and the fixed molding die 928. The plasticized material is injected from nozzle 14 into the cavity 924 of the molding die 922. The cavity 924 is a space corresponding to the shape of a molded article. The plasticized material flowing into the cavity 924 is cooled and solidified. This produces the molded article. The material of the movable molding die 926 and the fixed molding die 928 is metal. The material of the movable molding die 926 and the fixed molding die 928 may be ceramic or resin.

The molding die clamping section 930 includes, for example, a molding die drive section 932 and a ball screw section 934. The molding die drive section 932 is configured by, for example, a motor, a gear, and the like. The molding die drive section 932 is connected to the movable molding die 926 via the ball screw section 934. The driving of the molding die drive section 932 is controlled by the control section 40. The ball screw section 934 transmits power generated by driving of the molding die drive section 932 to the movable molding die 926. The molding die clamping section 930 opens and closes the mold section 920 by moving the movable molding die 926 using the molding die drive section 932 and the ball screw section 934.

The above-described embodiments and modifications are merely examples, and it is not limited thereto. For example, it is possible to appropriately combine the embodiments and the modifications.

The present disclosure includes substantially the same configuration as the configuration described in the embodiment, for example, it includes a configuration having the same function, method, and result, or a configuration having the same objective and effect. In addition, the disclosure includes a configuration in which a non-essential portion of the configuration described in the embodiment is replaced. Further, the present disclosure includes configurations that provides the same operation and effect as the configuration described in the embodiment or configurations that can achieve the same objective. In addition, the disclosure includes a configuration in which a known technology is added to the configuration described in the embodiment.

The following contents are derived from the above-described embodiments and modifications.

One aspect of a plasticizing device includes a material storage section that is configured to store a material and that is configured to discharge the material from an input port; a plasticizing section that includes a screw and a case accommodating the screw and in which is formed a supply port communicating with the input port, and that is configured to plasticize the material to generate a plasticized material; a connecting member that includes a transparent member and that is configured to bring the input port and the supply port into communication with each other; and a material sensor that includes a light emitting section that emits light toward the supply port via the transparent member and a light receiving section that receives reflected light of the light and that is configured to detect a remaining amount of the material, wherein the connecting member includes a material collision section against which the material input from the input port collides and the material collision section is provided between the input port and the transparent member.

According to this plasticizing device, it is possible to reduce possibility that the material input from the input port becomes deposited on the transparent member.

One aspect of a plasticizing device may be configured such that the connecting member includes a side wall section, the material collision section extends from the side wall section in a direction intersecting an input direction of the material and in a direction approaching the supply port, an opening section is formed in the side wall section, and the transparent member is provided in the opening section.

According to this plasticizing device, the material input from the input port can slide down the material collision section and be discharged to the supply port.

One aspect of a plasticizing device may be configured such that the material collision section extends in a direction intersecting an input direction of the material, the transparent member extends in a direction different from an extending direction of the material collision section and in a direction intersecting the input direction, and at least a part of the transparent member overlaps the material collision section when viewed from the input direction.

According to this plasticizing device, it is easy to make the incident angle of the light from the light emitting section to the transparent member close to vertical. Thus, the loss of light in the transparent member can be reduced.

One aspect of a plasticizing device may be configured such that the transparent member is configured to attach and detach.

According to this plasticizing device, even when the material becomes deposited on the transparent member, the transparent member can be replaced.

One aspect of a plasticizing device may be configured such that the connecting member includes another transparent member through which the reflected light passes.

According to this plasticizing device, when the light emitted from the light emitting section passes through the transparent member but is not received by the light receiving section, it is possible to detect that material has become deposited on the transparent member.

One aspect of a plasticizing device may be configured such that the material sensor has a predetermined measurement range.

According to this plasticizing device, by defining the measurement range of the material sensor so that a position of the transparent member is excluded from the measurement range of the material sensor, even when the material becomes deposited on the transparent member, it is possible to avoid detecting the material deposited on the transparent member.

One aspect of a plasticizing device may be configured such that a groove is formed in the screw and the material sensor detects the material in the groove.

According to this plasticizing device, it is possible to suppress running out of material in the groove during the molded layer forming process.

One aspect of a plasticizing device may be configured such that the material storage section includes a slide member in which a through hole is formed and a slide drive section that slides the slide member and the slide drive section is configured to, by sliding the slide member, switch between a first state in which the through hole and the input port communicate with each other and the material is input from the input port to the connecting member and a second state in which the through hole and the input port do not communicate with each other and the material is not input from the input port to the connecting member.

According to this plasticizing device, the supply amount of the material to the plasticizing section can be adjusted.

One aspect of a three dimensional molding device includes the one aspect of the plasticizing device and a nozzle that ejects the plasticized material supplied from the plasticizing device toward a stage.

One aspect of an injection molding device includes the one aspect of the plasticizing device and a nozzle that injects the plasticized material supplied from the plasticizing device toward a molding die.

What is claimed is:

1. A plasticizing device comprising:
a material storage section that is configured to store a material and that is configured to discharge the material from an input port;
a plasticizing section that includes a screw and a case accommodating the screw and in which is formed a supply port communicating with the input port, and that is configured to plasticize the material to generate a plasticized material;
a connecting member that includes a transparent member and that is configured to bring the input port and the supply port into communication with each other; and
a material sensor that includes a light emitting section that emits light toward the supply port via the transparent member and a light receiving section that receives reflected light of the light and that is configured to detect a remaining amount of the material, wherein
the connecting member includes a material collision section against which the material input from the input port collides and
the material collision section is provided between the input port and the transparent member.

2. The plasticizing device according to claim 1, wherein
the connecting member includes a side wall section,
the material collision section extends from the side wall section in a direction intersecting an input direction of the material and in a direction approaching the supply port,
an opening section is formed in the side wall section, and
the transparent member is provided in the opening section.

3. The plasticizing device according to claim 1, wherein
the material collision section extends in a direction intersecting an input direction of the material,
the transparent member extends in a direction different from an extending direction of the material collision section and in a direction intersecting the input direction, and
at least a part of the transparent member overlaps the material collision section when viewed from the input direction.

4. The plasticizing device according to claim 1, wherein
the transparent member is configured to attach and detach.

5. The plasticizing device according to claim 1, wherein
the connecting member includes another transparent member through which the reflected light passes.

6. The plasticizing device according to claim 1, wherein
the material sensor has a predetermined measurement range.

7. The plasticizing device according to claim 1, wherein
a groove is formed in the screw and
the material sensor detects the material in the groove.

8. The plasticizing device according to claim 1, wherein
the material storage section includes
a slide member in which a through hole is formed and
a slide drive section that slides the slide member and
the slide drive section is configured to, by sliding the slide member, switch between
a first state in which the through hole and the input port communicate with each other and the material is input from the input port to the connecting member and
a second state in which the through hole and the input port do not communicate with each other and the material is not input from the input port to the connecting member.

9. A three dimensional molding device comprising:
the plasticizing device according to claim 1 and
a nozzle that ejects the plasticized material supplied from the plasticizing device toward a stage.
